(19) United States
(12) Patent Application Publication
(10) Pub. No.: US 2008/0085942 A1
(43) Pub. Date: Apr. 10, 2008

(54) Coating system, method of coating, and coated articles

(76) Inventors: Scott Jackson, Rock Hill, SC (US); Pierre Defaux, Lyon (FR)

Correspondence Address: MIALEEKA WILLIAMS;RHODIA INC., 8 CEDAR BROOK DRIVE (CN7500), CRANBURY, NJ, 08512-7500, US

(21) Appl. No.: 11/543,696

(22) Filed: Oct. 5, 2006

(51) Int. Cl. C08J 11/04; C08F 2/46; C08J 7/18

(52) U.S. Cl. 521/47.5; 427/487

(57) ABSTRACT

Airbag fabric is coated with a primer followed by a coating composition to form airbags which retain gas for exceptionally long periods after rapid deployment with low coatweights, resulting in improved airbags, especially side curtain airbags of the one piece woven type. The primer is formed from an ethylenically unsaturated monomer/functionalized polyorganosiloxane mixture in a water/emulsifying agent mixture; and the coating is a reinforcing mineral filler-free composition comprising a mixture of (1) at least one polyorganosiloxane with alkenyl groups bound to the silicon; (2) at least one polyorganosiloxane with hydrogen atoms bound to the silicon; (3) a cross-linking catalyst; (4) an adhesion promoter comprising (4.1) at least one alkoxylated organosilane, (4.2) at least one epoxy-functional organosilicon compound, and (4.3) at least one metal chelate and/or metal alkoxide wherein the metal is selected from the group which consists of Ti, Zr, Ge, Li, Mn, Fe, Al and Mg; (5) at least one polyorganosiloxane resin; and optionally a non-reinforcing filler.

### BACKGROUND OF THE INVENTION

This invention relates to coating, and particularly relates to airbag coating compositions and systems, methods, and articles.

Airbags for vehicles must be manufactured to extremely high standards so that they inflate properly when the vehicle is in an accident and function to protect the passengers. Airbags must meet several specifications, among which are the ability to retain gas for a specified amount of time when inflated by a mechanically and thermally aggressive gas generator, tear strength, combing strength, weight, to name a few.

Inflatable curtain airbags, known as side airbags or side curtain airbags, protect passengers from side impact, and have different specifications than front impact airbags. Conventional side curtain airbags are constructed of one piece woven (OPW) fabric which has seams. Side curtain airbags must have extremely low air permeability as compared to front airbags since the side bags must remain inflated for at least 10 seconds for protection in case of a long lateral impact such as multiple rolls of a vehicle during a rollover event.

OPW side curtain airbags are typically coated with liquid silicone rubber (LSR) at a coating weight of 125-150 g/m² over the entire outside of the airbag since lower coat weights of LSR are not sufficient to meet the minimum 10 seconds inflation specification. Furthermore, coating weights of over 125 g/m² interfere with the ability to pack the bags. Another problem with some LSR coated side curtain airbags is when coated portions stick together at time of deployment because of high coefficients of friction and the interaction of silicone to silicone when a heavy-coated fabric is folded on itself, leading to airbags which will not completely inflate or, in severe cases, will not inflate at all.

Coating systems other than LSR for curtain side airbags have been proposed, but have not been successful due to either delamination, bad adhesion onto substrate, or very poor resistance to aging.

There is a need to provide improved coating systems for airbag fabrics, especially for side curtain airbags, which meet the minimum 10 seconds inflation specification with low coat weights, high resistance to aging, good adhesion to the fabric substrate, and are non-blocking.

### SUMMARY OF THE INVENTION

We have discovered a new coating system useful for airbags comprising (A) a latex primer and (B) a reinforcing mineral filler-free polyorganosiloxane coating. The primer is formed by polymerizing in the presence of a water-soluble or water-dispersible initiator, at a temperature at least equal to that of decomposition of the initiator, an ethylenically unsaturated monomer/functionalized polyorganosiloxane mixture in a water/emulsifying agent mixture. The coating can be prepared by curing a reinforcing mineral filler-free composition comprising a mixture of (1) at least one polyorganosiloxane with alkenyl groups bound to the silicon; (2) at least one polyorganosiloxane with hydrogen atoms bound to the silicon; (3) a cross-linking catalyst; (4) an adhesion promoter comprising (4.1) at least one alkoxylated organosilane, (4.2) at least one epoxy-functional organosilicon compound, and (4.3) at least one metal chelate and/or metal alkoxide wherein the metal is selected from the group which consists of Ti, Zr, Ge, Li, Mn, Fe, Al and Mg; (5) at least one polyorganosiloxane resin; and (6) optionally at least one cross-linking inhibitor. The coating is preferably applied immediately after curing the primer.

The invention also comprises a fabric substrate coated on each side with the cured primer and the cured coating and airbags, especially curtain side airbags, formed from such coated fabric.

In another aspect, the invention comprises a method of coating a substrate, for example a fabric, comprising applying to each side a latex primer comprising at least one ethylenically unsaturated monomer, at least one functionalized polyorganosiloxane, and at least one water-soluble or water-dispersible initiator on each of the two sides; (b) polymerizing the latex primer; (c) immediately applying to the cured primer a reinforcing mineral filler-free coating composition comprising a (1) at least one polyorganosiloxane with alkenyl groups bound to the silicon; (2) at least one polyorganosiloxane with hydrogen atoms bound to the silicon; (3) a cross-linking catalyst; (4) an adhesion promoter comprising (4.1) at least one alkoxylated organosilane, (4.2) at least one epoxy-functional organosilicon compound, and (4.3) at least one metal chelate and/or metal alkoxide wherein the metal is selected from the group which consists of Ti, Zr, Ge, Li, Mn, Fe, Al and Mg; (5) at least one polyorganosiloxane resin; and (6) optionally one or more cross-linking inhibitors; and (d) curing the coating composition.

### DETAILED DESCRIPTION

In the field of side curtain airbags, the preferred fabrics are polyamides and polyesters, nylon being the most conventional fabric material, and one piece woven (OPW) being the most conventional construction. The present invention is not limited to the particular fabric or construction, and does not require a special construction or fabric material to deliver the improved gas retention times we have discovered.

Using conventional fabric coating equipment, the primer can be applied only at the seam area of the airbag, followed by application of the coating composition over the entire surfaces of both sides of the fabric, with excellent results. It is often advantageous, however, to prime the entire surfaces of the fabric with the primer, followed immediately by application of the coating composition, since applying primer only to the seams requires changes to current equipment and techniques.

When the coating is applied immediately after curing the primer, as can be easily accomplished with in line dual coating processes, the adhesion between the primer and coating layers is extremely good.

Adhesion can also be enhanced by adding emulsified polyorganosiloxanes to the primer, for example reactive silicone oils and/or silicone resins, and/or adhesion promoters, to the primer emulsion. Adhesion promoters such as silanes can be added to the coating composition as well.

The primer is a water based emulsion, free of organic solvents, with low viscosity which provides mechanical adhesion to the fabric substrate. The primer has excellent strength and very good stability after heat and aging. Furthermore, when dried, the primer has a physical profile similar to a high strength liquid silicone rubber.

The primer comprises water-soluble or water-dispersible initiator, ethylenically unsaturated monomer, functionalized polyorganosiloxane mixture, water, and emulsifying agent.

Examples of categories of suitable ethylenically unsaturated monomers for the primer include (i) monoethylenically unsaturated esters of a saturated carboxylic acid; (ii) saturated esters or monoethylenically unsaturated carboxamides; (iii) monoethylenically unsaturated nitrites; (iv) monoethylenically unsaturated carboxylic acids; (v) hydroxyalkyl or aminoalkyl esters of monoethylenically unsaturated carboxylic acids; (vi) vinylaromatic monomers; and (vii) dicyclopentadienyl acrylate or methacrylate.

Examples of suitable functionalized polyorganosiloxanes for the primer include any having the formula

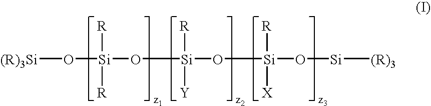

wherein R are the same or different and represent a linear or branched C₁-C₁₈ alkyl group, a linear or branched C₂-C₂₀ alkenyl group, or a C₆-C₁₂ aryl or aralkyl group, and is optionally substituted with halogen atoms; X are the same or different and represent a reactive function linked to a silicon atom by an Si—C or Si—O—C bond and is an epoxy functional hydrocarbon group containing from 2 to 20 carbon atoms; Y are the same or different and represent an ethylenically unsaturated hydrocarbon residue which optionally contains one or more hetero elements O or N, the residue being linked to a silicon atom of the moiety of formula (I) by an Si—C bond and being capable of reacting via a radical route with at least one ethylenically unsaturated monomer; Z₁, Z₂ and Z₃ represent numbers of moieties; the number of moieties Z₂ and Z₃ of formula (I) being such that the polyorganosiloxanes contain from 1 to 100 milliequivalents of functions X per 100 grams of polyorganosiloxane of formula (I); and from 10 to 500 milliequivalents of residues Y per 100 grams of polyorganosiloxane of formula (I).

Suitable emulsifying agents in the primer include standard anionic agents such as fatty acid salts, alkyl sulphates, alkyl sulphonates, alkyl aryl sulphonates, sulphosuccinates, alkyl phosphates of alkali metals, hydrogenated or nonhydrogenated salts of abietic acid, nonionic agents such as polyethoxylated fatty alcohols, polyethoxylated and optionally sulphated alkylphenols, polyethoxylated fatty acids, alone or in combination, for example. These emulsifying agents may be used at a proportion of 0.1 to 3% by weight relative to the total weight of ethylenically unsaturated monomer and functionalized polyorganosiloxane.

The initiators which may be used in the primer are of the water-soluble or water-dispersible type, for instance hydroperoxides such as aqueous hydrogen peroxide, cumene hydroperoxide, tert-butyl hydroperoxide and diisopropylbenzene hydroperoxide, persulphates such as sodium persulphate, potassium persulphate, ammonium persulphate, for example. These initiators may be used at a proportion of 0.01 to 4%, preferably of 0.05 to 2%, by weight relative to the total weight of ethylenically unsaturated monomer and functionalized polyorganosiloxane. These initiators are optionally combined with a reducing agent, such as bisulphites or sodium formaldehydesulphoxylate, polyethyleneamines, sugars such as dextrose and sucrose, and metal salts of ascorbic acid. The amounts of reducing agent used may range up to 3% by weight relative to the weight of the monomer(s)+functionalized polyorganosiloxane mixture.

Chain-limiting agents may optionally be present in proportions ranging from 0 to 3% by weight relative to the monomer(s) and functionalized polyorganosiloxane mixture. They are generally chosen from mercaptans such as N-dodecylmercaptan and tert-dodecylmercaptan; cyclohexene; halogenated hydrocarbons such as chloroform, bromoform, carbon tetrachloride and carbon tetrabromide; and α-methylstyrene dimers, for example.

The polyorganosiloxanes used are preferably in the form of a reactive, stable aqueous dispersion generally having a solids content of about 5 to 60%, more preferably of about 25 to 50%, by weight. The aqueous dispersions may be obtained by radical polymerization in aqueous emulsion or in microsuspension of at least one ethylenically unsaturated monomer in the presence of the said functionalized polyorganosiloxane containing similar or different moieties of formula (I).

The respective amounts of ethylenically unsaturated monomer and of functionalized polyorganosiloxane which may be used in the primer correspond to a monomer/polyorganosiloxane weight ratio of about 98-50/2-50, preferably of about 95-75/5-25.

The compositions and methods of application of the primers have been disclosed as useful for other purposes (anti-adhesive agents and/or water repellents for sheets of polymer material or of paper, cardboard or the like, from tapes which are adhesive on their non-adhesive side, from intercalating films of double-sided adhesive tapes or from woven or non-woven fibrous supports and/or composites or non-composites) in U.S. Pat. No. 5,767,206, to Ariagno, et al., which is hereby incorporated by reference for its teaching of suitable compositions useful in the present invention as the primer. One preferred primer material is currently commercially available from Rhodia, Inc., as PC-800.

The rate of application of the primer can be about 10-30 g/m² and is preferably applied at 15-20 g/m² on each side, simultaneously or sequentially.

The polymerization of the emulsion, sometimes referred to as curing of the primer, takes place at or above the decomposition temperature of the initiator, preferably in most cases at 180° C. for about 10 seconds which are typical conditions for the type of industrial ovens.

After the primer emulsion is cured, the elastomer coating is applied, at a rate of about 35-90 g/m² per side, more preferably at about 70-90 g/m² per side, and most preferably from about 70-80 g/m² per side. The respective amounts of primer and coating are selected so that the gas retention of the coated air bag meets the desired specifications. In the case of side curtain airbags, at least 10 seconds of air retention is needed. Depending on the test methods, i.e., from 70-40 kPa static, 100-50 kPa static, or 100-50 kPa dynamic, coat weights of 70 g/m² have been found to meet the 10 seconds retention requirement.

The coating is a reinforcing mineral filler-free composition comprising a mixture of (1) at least one polyorganosiloxane with alkenyl groups bound to the silicon; (2) at least one polyorganosiloxane with hydrogen atoms bound to the silicon; (3) a cross-linking catalyst; (4) an adhesion promoter comprising (4.1) at least one alkoxylated organosilane, (4.2) at least one epoxy-functional organosilicon compound, and (4.3) at least one metal chelate and/or metal alkoxide wherein the metal is selected from the group which consists of Ti, Zr, Ge, Li, Mn, Fe, Al and Mg; (5) at least one polyorganosiloxane resin; and (6) optionally at least one cross-linking inhibitor. A non-reinforcing filler, calcium carbonate, can be included in the coating composition.

Preferred coating compositions are described in detail in U.S. Pat. No. 6,586,551, to Bohin, et al, which is hereby incorporated in reference for its disclosure of examples of suitable coating compositions. One especially preferred coating composition is available commercially from Rhodia, Inc. as TCS 7534, formerly TCS 7159.

### EXAMPLES

The following examples, in which all parts and percentages are by weight unless otherwise indicated, are presented to illustrate a few embodiments of the invention but are not to be construed as limiting in any way.

### Example 1

### Preparation of the Primer

A water based emulsion was prepared at a solids content of 40% silicone-grafted latex (SGL) formed from the following ingredients:

Methyl methacrylate, 35 parts; Butyl acrylate, 45 parts; Acrylic acid, 5 parts; Acrylate-grafted polydimethylsiloxane (PDMS) oil, 15 parts. The unsaturated organopolysiloxane oil assaying at 31 meq/100 g of glycidyl ether functions, of the following average formula was prepared according to Example 1 of U.S. Pat. No. 5,767,206.

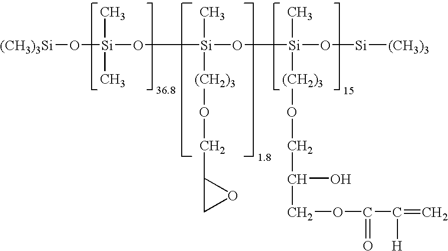

The acrylic monomers and diorganopolysiloxane mixture was introduced into a solution of 180 g of deionized water and 3.9 g of a 38.5% by weight aqueous solution of sodium dodecylbenzenesulphonate (Na-DBS) to form a preemulsion of the latex primer. The emulsion was polymerized according to the aforementioned example of U.S. Pat. No. 5,767,206.

### Example 2

### Preparation of the Coating Composition

A silicone coating composition was prepared according to Example 1 of U.S. Pat. No. 6,586,551 and then adding 16% by weight based on the resin of calcium carbonate as non-reinforcing filler.

1.1 Preparation of Starting Materials.
1. The following are mixed in a reactor, at room temperature: 48 parts by weight of resin having a MMVI DDVI Q structure containing 0.6% by weight of vinyl groups (Vi) and consisting of 17% by weight of (CH₃)₃SiO_{0.5} functional units, 0.5% by weight of (CH₃)₂ViSi_{0.5} functional units, 75% by weight of (CH₃)₂SiO functional units, 1.5% by weight of (CH₃)ViSiO functional units and 6% by weight of SiO₂ functional units [this constituent being called resin (5) hereafter]; 29 parts by weight of a polyorganosiloxane (1) consisting of a polydimethylsiloxane oil terminated at each of the chain ends by a (CH₃)₂ ViSiO_{0.5} functional unit, having a viscosity of 100,000 mPa·s and containing 0.003 Vi-Si functional groups per 100 g of oil [this constituent being called hereafter high-viscosity oil (1)]; 6 parts by weight of a polyorganosiloxane (2) consisting of a poly(dimethyl)(hydrogenomethyl)-siloxane oil terminated at each of the chain ends by a (CH₃)₂HSiO_{0.5} functional unit, having a viscosity of 25 mPa·s and containing in total 0.7 H—Si functional groups per 100 g of oil (of which 0.6 H—Si functional groups lie within the chain) [this constituent being called hereafter oil (2)]; 0.025 parts by weight of inhibitor (6) consisting of ethylcyclohexanol [this constituent being called hereafter inhibitor (6)]; 1 part by weight of compound (4.1) of the promoter (4), consisting of vinyltrimethoxysilane [this constituent being called hereafter VTMS (4.1)]; and 1 part by weight of compound (4.2) of the promoter (4), consisting of 3-glycidoxypropyltrimethoxysilane [this constituent being called hereafter GLYMO (4.2)]. A non-reinforcing filler, calcium carbonate, is included at 16 parts by weight.

1.2—Preparation of Part B of the Two-Component System

The following are mixed in a reactor at room temperature: 45 parts by weight of resin (5); 51 parts by weight of high-viscosity oil (1); 0.0215 parts by weight of platinum metal, introduced in the form of an organometallic complex (Karstedt catalyst) containing 10% by weight of platinum metal [this constituent being called hereafter platinum of the catalyst (3)]; and 4 parts by weight of compound (4.3) of the promoter (4), consisting of butyl titanate Ti(OBu)4 [this constituent being called hereafter Ti(OBu)4 (4.3)].

1.3—Preparation of the Two-Component System

The two-component system is obtained by mixing, at room temperature, 100 parts by weight of part A and 10 parts by weight of part B. Composition C1 is thus obtained, the proportions of the constituents of which are as follows:

TABLE I
Compositions

| | |
|---|---|
| Resin (5) | 47.57 |
| High-viscosity oil (1) | 29.69 |
| Oil (2) | 5.46 |
| Inhibitor (6) | 0.023 |
| Platinum of the catalyst (3) | 0.002 |
| VTMS (4.1) | 0.91 |
| GLYMO (4.2) | 0.91 |
| Ti(OBu)4 (4.3) | 0.36 |
| Calcium Carbonate | 15.1 |
| Total | 100.00 |

### Example 3

### Application of Primer

The primer of Example 1 was applied to each side of several sheets of Nylon fabric using a J or I knife over a roll at approximately 15-20 g/m² per side followed by heating at 180° C. for 10 seconds.

### Example 4

### Application of Coating

The coating composition of Example 2 was applied to the sheets immediately after the heating step of Example 3 at three different rates as reported in Table II, and the air retention at three different testing methods was measured and the results are also reported in Table II.

### Example 5

### Comparative

OPW Nylon 6,6 fabric bags were coated directly with the coating composition of Example 2 either with primer, with the total coatweight (primer and elastomeric coating weights) reported as “Invention” in Table II, or without first applying any latex primer, reported as “Comparative” in Table II.. The results show that less total coating is needed to achieve improved air retention times by the invention versus conventional systems.

TABLE II
Average Air Retention, secs

| Coatweight range, | 70–40 kPa | | |
|---|---|---|---|
| g/m² | Static | 100–50 kPa Static | 100–50 kPa Dynamic |
| Invention | | | |
| 35–50 | 9.3 | 9.9 | NA |
| 70–80 | 32.3 | 36.6 | 20.2 |
| 80–90 | 47.5 | 60.2 | 21.6 |
| Comparative | | | |
| 65–75 | 11.1 | 7.6 | 3 |
| 100–110 | 41.2 | 23 | 11.8 |

The comparative results reported in Table II demonstrate that it is necessary to increase the total elastomer coatweight to greater than 100 g/m² to pass the 10 seconds minimum dynamic test without the primer (Comparative) but that only 70-80 g/m² of combined primer and elastomer coating is needed to pass such test.

### Example 6

### Heat and Humidity Testing

The OPW bags coated according to Example 4 were exposed to standard heat and humidity aging conditions and measured according to [What are the units for the 38.64, 74.75, etc.?] The results in Table III below show average results at 72 hours after coating (Before Aging) versus after 14 days at 80° C. and 95% relative humidity.

| Method | Before Aging | After Aging |
|---|---|---|
| 70 to 40 Static | 38.64 | 74.75 |
| 100 to 50 static | 45.14 | 83.96 |
| 100 to 50 dynamic | 21.63 | 36.75 |

The 91.44 and 84.14 are coating weights on each side.

While the invention and its advantages have been described and exemplified in detail, other embodiments, substitutions, and alterations should become readily apparent to those skilled in this art without departing from the spirit and scope of the invention.

What is claimed is:

1. A coating system for airbags comprising (A) a latex primer formed by polymerizing in the presence of a water-soluble or water-dispersible initiator, at a temperature at least equal to that of decomposition of the initiator, an ethylenically unsaturated monomer/functionalized polyorganosiloxane mixture in a water/emulsifying agent mixture; and (B) a coating prepared by curing a reinforcing mineral filler-free composition comprising a mixture of (1) at least one polyorganosiloxane with alkenyl groups bound to the silicon; (2) at least one polyorganosiloxane with hydrogen atoms bound to the silicon; (3) a cross-linking catalyst; (4) an adhesion promoter comprising (4.1) at least one alkoxylated organosilane, (4.2) at least one epoxy-functional organosilicon compound, and (4.3) at least one metal chelate and/or metal alkoxide wherein the metal is selected from the group which consists of Ti, Zr, Ge, Li, Mn, Fe, Al and Mg; (5) at least one polyorganosiloxane resin; and (6) optionally at least one cross-linking inhibitor.

2. The coating system of claim 1 wherein the primer is applied at a rate of about 10-30 g/m² and the second coating is applied at a rate of about 35-90 g/m².

3. The coating system of claim 1 wherein the primer is applied at a rate of about 15-20 g/m² and the second coating is applied at a rate of about 70-90 g/m².

4. The coating system of claim 1 wherein the primer is cured for about 10 seconds at about 180° C. and the second coating is cured for about 60 seconds at 180° C.

5. The coating system of claim 1 prepared by applying and curing the second coating immediately after applying and polymerizing the primer.

6. A one piece woven (OPW) fabric airbag coated with a coating system according to claim 1.

7. The airbag of claim 6 wherein the fabric is a polyamide or polyester.

8. The airbag of claim 6 in the form of a OPW fabric curtain side airbag capable of retaining air pressure after inflation for at least 10 seconds.

9. The airbag of claim 6 form of a curtain side airbag formed from a polyamide or polyester fabric which retains air pressure after inflation for at least 30 seconds at a static pressure of 100 kPa, and at least 20 seconds at a dynamic pressure of 100 to 50 kPa.

10. The airbag of claim 6 wherein the fabric is nylon 6.6, the primer comprises methyl methacrylate, butyl acrylate, acrylic acid, 5 parts; and acrylate-grafted polydimethylsiloxane (PDMS) oil.

11. The airbag of claim 10 wherein the oil has following average formula:

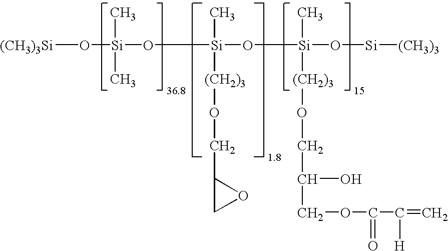

12. The airbag of claim 11 wherein the primer is applied at about 10-12 g/m², cured for about about 10 seconds at about 180° C., and the elastomer coating is applied at a coating weight of about 65-70 g/m², and cured for 60 seconds at about 180° C.

13. A method of coating a OPW fabric airbag comprising (a) applying to the airbag a latex primer comprising at least one ethylenically unsaturated monomer, at least one functionalized polyorganosiloxane, and at least one water-soluble or water-dispersible initiator; (b) heating to polymerize and cure the latex primer; (c) immediately applying to the cured primer a reinforcing mineral filler-free elastomer coating composition comprising a (I) at least one polyorganosiloxane with alkenyl groups bound to the silicon; (2) at least one polyorganosiloxane with hydrogen atoms bound to the silicon; (3) a cross-linking catalyst; (4) an adhesion promoter comprising (4.1) at least one alkoxylated organosilane, (4.2) at least one epoxy-functional organosilicon compound, and (4.3) at least one metal chelate and/or metal alkoxide wherein the metal is selected from the group which consists of Ti, Zr, Ge, Li, Mn, Fe, Al and Mg; (5) at least one polyorganosiloxane resin; and (6) optionally one or more cross-linking inhibitors; (7) optionally one or more non-reinforcing fillers and (d) curing the elastomer coating composition.

14. The method of claim 13 wherein the fabric is polyamide or polyester.

15. The method of claim 13 comprising applying the primer at a rate of 10-30 g/m² and applying the elastomer coating at a rate of at a rate of 70-90 g/m² per side.

16. The method of claim 13 comprising curing the primer for about 8-12 seconds at about 170-190° C. and curing the elastomer coating for about 50-70 seconds at about 170-190° C.

17. The method of claim 13 wherein the fabric is formed after curing the elastomer coating into a one piece woven fabric side curtain airbag having seams.

18. The method of claim 13 wherein the coating composition comprises calcium carbonate as non-reinforcing filler.

19. The method of claim 13 wherein the primer is applied at about 10 to 12 g/m² and cured for about 10 seconds at 180° C., and wherein the coating is applied at about 65 to 70 g/m² and cured for about 60 seconds at 180° C.

20. Polyamide or polyester fabric useful for construction of airbags coated with a coating system according to claim 1.
